(19) United States
(12) Patent Application Publication
(10) Pub. No.: US 2013/0125021 A1
(43) Pub. Date: May 16, 2013

(54) TABLET ALL-IN-ONE APPLICATION

(71) Applicant: Conceptus Inc., Mountain View, CA (US)

(72) Inventors: Jeffrey C. Letasse, Pleasanton, CA (US); Ulric Cote, Oakland, CA (US); Todd Sloan, Saratoga, CA (US); John Ghashghai, Cupertino, CA (US)

(73) Assignee: Conceptus Inc., Mountain View, CA (US)

(21) Appl. No.: 13/672,559

(22) Filed: Nov. 8, 2012

Related U.S. Application Data
(60) Provisional application No. 61/558,276, filed on Nov. 10, 2011.

(51) Int. Cl. G06F 3/048

(52) U.S. Cl. CPC G06F 3/048; H04L 51/00
USPC 715/752

(57) ABSTRACT

A method and apparatus for an all-in-one tablet application is described herein. In one embodiment, an application presents marketing data on a visual display of the computing system viewable to a user. The application retrieves stored information from a remote Customer Relationship Management (CRM) server for processing by the computing system. The application presents a visual representation on the visual display of the computing system to allow a user to update or edit CRM content. The application provides an email interface to allow the user to send an email to a customer visited by the user.

This application claims the benefit of priority to U.S. provisional patent application No. 61/558,276 which was filed on Nov. 10, 2011 and which is incorporated herein by reference.

### FIELD OF THE INVENTION

The field of invention relates generally to tablet computing systems, and, more specifically, to an all-in-one application for tablet computing systems.

### BACKGROUND

Existing computing systems provide a convenient way to view visual representations of media or other content. A sales representative can use a computing system to present a marketing presentation to a customer. Existing desktop computer systems include software that allow a sales representative to login to a Customer Relationship Management (CRM) server in order to update information about the customer. The sales representative can also login to an email account to send an email to the customer. In order to perform these tasks, the sales representative needs to login to several accounts or use several different programs and is not presented with a application that allows the user to perform these tasks quickly and easily.

### SUMMARY OF THE DESCRIPTION

Mechanisms for an all-in-one application running on a data processing system such as a tablet computer are described herein. The application presents marketing data on a visual display of the system viewable to a user. The application can retrieve stored information from a remote Customer Relationship Management (CRM) server for processing or editing by the system. The application presents a visual representation on the visual display of the system to allow a user to update or edit CRM content. The application provides an email interface to allow the user to send an email to a customer visited by the user.

Systems, methods, and machine readable storage media which perform or implement one or more embodiments are also described.

Other features of the present invention will be apparent from the accompanying drawings and from the detailed description which follows.

### BRIEF DESCRIPTION OF THE DRAWINGS

The present invention is illustrated by way of example and not limited in the figures of the accompanying drawings, in which like references indicate similar elements and in which:

FIG. 1 illustrates an exemplary all-in-one architecture including a tablet computing system, servers, and storage connected over a network in which embodiments of the present invention may operate;

FIG. 2A illustrates one embodiment of an exemplary visual representation presented on a display in accordance with embodiments of the present invention;

FIG. 2B illustrates an alternate embodiment of an exemplary visual representation presented on a display in accordance with embodiments of the present invention;

FIG. 3 illustrates an exemplary visual representation of marketing data presented on a display in accordance with embodiments of the present invention;

FIGS. 4A, 4B, 4C, 4D, and 4E illustrate exemplary visual representations of CRM content presented on a display in accordance with embodiments of the present invention;

FIG. 5 illustrates a flow diagram of a tablet all-in-one application method in accordance with embodiments of the present invention; and

FIG. 6 illustrates a block diagram of an exemplary tablet computing system in which embodiments of the present invention may operate.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

A tablet computing system running an all-in-one application can be used by a sales representative to provide an integrated, easy to use way for a sales representative to present marketing materials to a customer, retrieve CRM information for processing or editing by the sales representative, and display a post-sales visit window to allow the sales representative to update or edit CRM content, and to send an email to the customer.

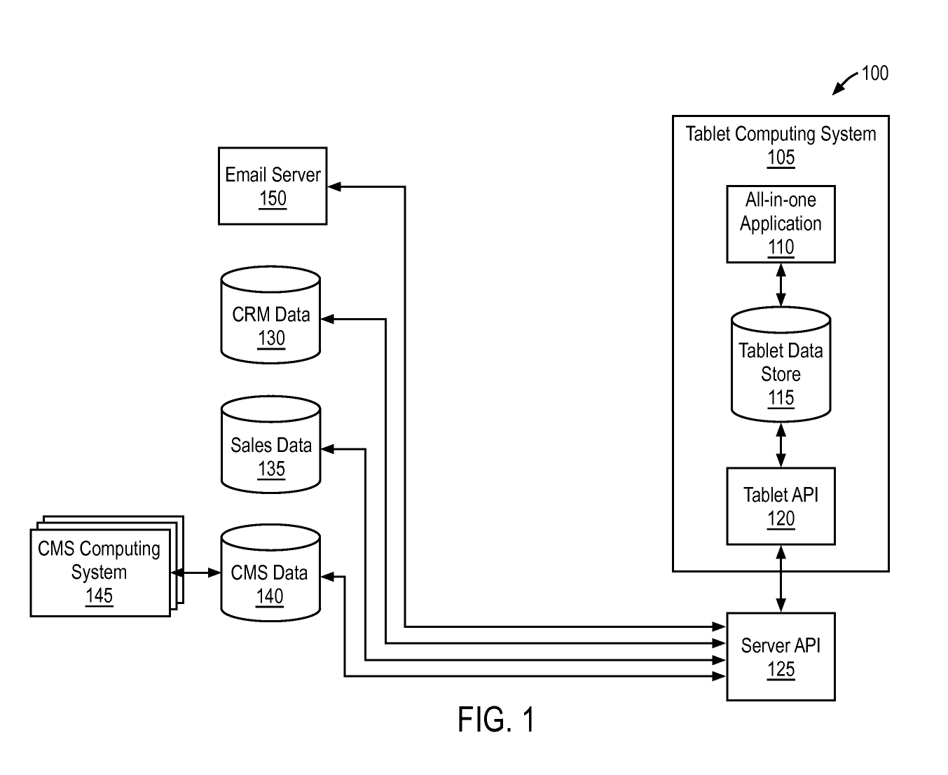

FIG. 1 illustrates an exemplary all-in-one system architecture 100 in which the tablet all-in-one application may be executed. All-in-one system architecture 100 includes tablet computing system 105, server API (Application Programming Interface) 125, CRM data 130, sales data 135, CMS (Content Marketing/Sales) data 140, one or more CMS computing systems 145, and email server 150. The CRM data 130, the sales data 135, and the CMS data 140 can be data storage systems provided by one or more servers or other types of storage systems such as Network Attached Storage (NAS) or Storage Area Network(s) (SAN), etc. A web server can also be provided in this architecture, and the web server can provide attachments for emails generated through the email interface on the tablet system 105. Tablet computing system 105 communicates with CRM data 130, sales data 135, CMS data 140, and email server 150 through server API 125. In one embodiment, server API 125 can be a secure internet protocol. In some embodiments server API 125 defines a standard way to exchange requests and responses based on a common transport and an agreed upon data/message exchange format with tablet computing system 105, CRM data 130, sales data 135, CMS data 140, and email server 150. The server 125 API can be implemented on one or more servers that receive and transmit data from/to the tablet system 105.

The tablet computing system 105 can be hosted by any type of handheld computers or similar computing device. In one embodiment, the tablet computing system 105 is an Apple IPAD™. Tablet computing system 105 can include all-in-one application 110, tablet data store 115, and tablet API 120. In other embodiments, rather than a tablet form factor, the system 105 can be a laptop computer or a desktop computing system. In one embodiment, the tablet form factor can be a rectangular slab, with or without rounded corners, that is less than one inch thick and has length dimensions that range from about five inches to eleven inches and has width dimensions that range from about three inches to nine inches, and the tablet form factor has no integrated (built-in) physical keyboard but uses a virtual keyboard displayed on the display of the tablet computing system. The display occupies a large portion (e.g., over 70%) of a top surface of the rectangular slab and a touch input device is overlaid onto the display. The tablet form factor also has no hinge between a physical keyboard and a display.

All-in-one application 110 can present marketing data on a visual display of tablet computing system 105, such that the marketing data can be viewed by a user. In one embodiment, the marketing data is presented by a sales representative and is viewed by a customer that the sales representative is visiting. In one embodiment, the marketing data can be stored in tablet data store 115. In an alternate embodiment, the marketing data can be stored in CMS data 140.

All-in-one application 110 can retrieve stored information from CRM data 130 for processing or editing by tablet computing system 105. In some embodiments, the retrieved information can include customer-specific data (e.g., CRM data) for a customer selected by the user (e.g., sales representative).

All-in-one application 110 can present a visual representation on the visual display of tablet computing system 105 to allow a user (e.g., sales representative) to update or edit CRM content retrieved by the all-in-one application 110. In some embodiments, the visual representation is a post-sales visit window that can allow a user (e.g., sales representative) to simultaneously see and interact with multiple viewing areas to update information (e.g., CRM information, sales information, and inventory information) and to create an email and to include the marketing material as attachments to the email. In one embodiment, the updated CRM content is stored in tablet data store 115. In an alternate embodiment, the all-in-one application 110 can determine the data that was updated and send the updated content to the appropriate data structure. For example, all-in-one application 110 may determine that the user has updated CRM content (such as address of a customer, names of individuals at the customer's site, etc.), and can send the updated CRM content to CRM data 130 to be stored. In another example, all-in-one application 110 may determine that the user has updated sales content (e.g., number of units sold to a customer, current inventory owned by the customer, etc.), and can send the updated sales content to sales data 135 to be stored.

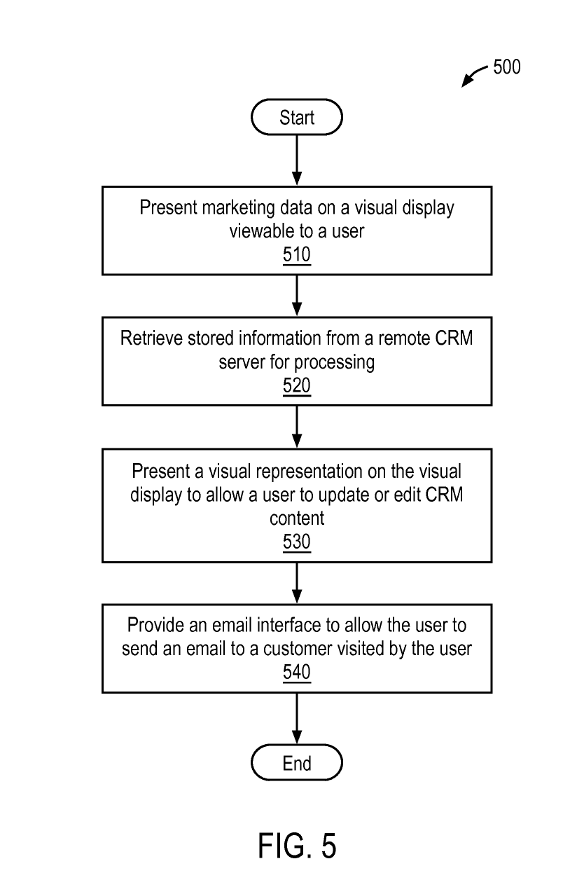

All-in-one application 110 can provide an email interface to allow the user (e.g., sales representative) to send an email to a customer visited by the user. In some embodiments, the email interface is included in the visual representation presented by the all-in-one application 110. In an alternate embodiment, the email interface is presented after the visual representation that allows the user to update or edit CRM content is presented. In some embodiments, the email interface can allow the user (e.g., sales representative) to send an email to a customer (e.g., customer just visited). In some embodiments, the email interface can allow the user to include an attachment to the email. In some embodiments, the attachment is marketing material shown during the sales visit (such as the marketing materials stored on the system 105 and shown in operation 510 of FIG. 5) to follow-up to the sales visit selected by the user via the visual representation. In one embodiment, the email can be sent by the customer using email server 150. In some embodiments, all-in-one application 110 can send an indication to CRM data 130 that an email has been sent via the email interface. In some embodiments, the content of the email, including attachments, sent to the customer is stored in email server 150, CRM data 130, sales data 135, or CMS data 140, and is not stored in tablet data store 115 in order to save data storage space on tablet computing system 105. In some embodiments, an attachment in an email is sent directly from the data structure storing the data (e.g., CRM data 130, sales data 135, CMS data 140), and is not sent from the computing system 105.

In some embodiments, all-in-one application 110 can display more than one visual representation for a user. For example, the user may select a specific customer for which CRM data is retrieved, then select several different marketing materials to send to the user. In one embodiment, all-in-one application 110 can track each of the visual representations presented on the visual display of computing system 105 (e.g., every marketing material presented can be tracked so a marketing executive can review what materials are being used and which ones are not and prune or enhance the materials) and update information in CRM data 130 based on the tracked visual representations. In an alternate embodiment, all-in-one application 110 can track the marketing data that is selected, viewed, or attached in an email for a customer in CRM data 130, and update information for that customer in CRM data 130 based on the tracked marketing data.

In some embodiments, all-in-one application 110 can wipe (e.g., erase, remove) data from tablet data store 115, in response to a command from a remote server. All-in-one application 110 can wipe the data in tablet data store 115 by sending a command, in response to the command from the remote server, including an address of the data to be erased and a size of the data to be erased to tablet data store 115.

In some embodiments, all-in-one application 110 can track the physical location of the tablet computing system 105, allowing the tablet computing system 105 to be retrieved or found if the tablet computing system 105 is lost or stolen. The all-in-one application 110 can include a Global Positioning System (GPS) daemon to determine a location of the tablet computing system 105. In one embodiment, the GPS daemon is downloaded as part of the all-in-one application 110. In one embodiment, the GPS daemon is a daemon application (not shown) that is installed onto tablet computing system 105 when all-in-one application 110 is downloaded from a website. In one embodiment, the website is operated by a seller of products included in CRM data 130.

CRM data 130 can store customer relationship management information (e.g., interactions with customers, communications with customers, customer data, such as contact information includes addresses, phone numbers, etc., contract data, etc.).

Sales data 135 can store sales data (e.g. number of units sold to this customer, current inventory owned by customer, etc.). In some embodiments, CRM data 130 and sales data 135 can be hosted by the same computing device which are accessible to the system 105 through one or more networks. In other embodiments, CRM data 130 and sales data 135 are hosted by different computing devices which are accessible to the system 105 through one or more networks.

CMS data 140 can store CMS data (e.g., marketing material, marketing presentations, sales material, etc.). CMS data 140 can be hosted by one or more CMS computing systems 145. CMS computing systems 145 can be any type of computing device including server computers, desktop computers, laptop computers, handheld computers or similar computing device.

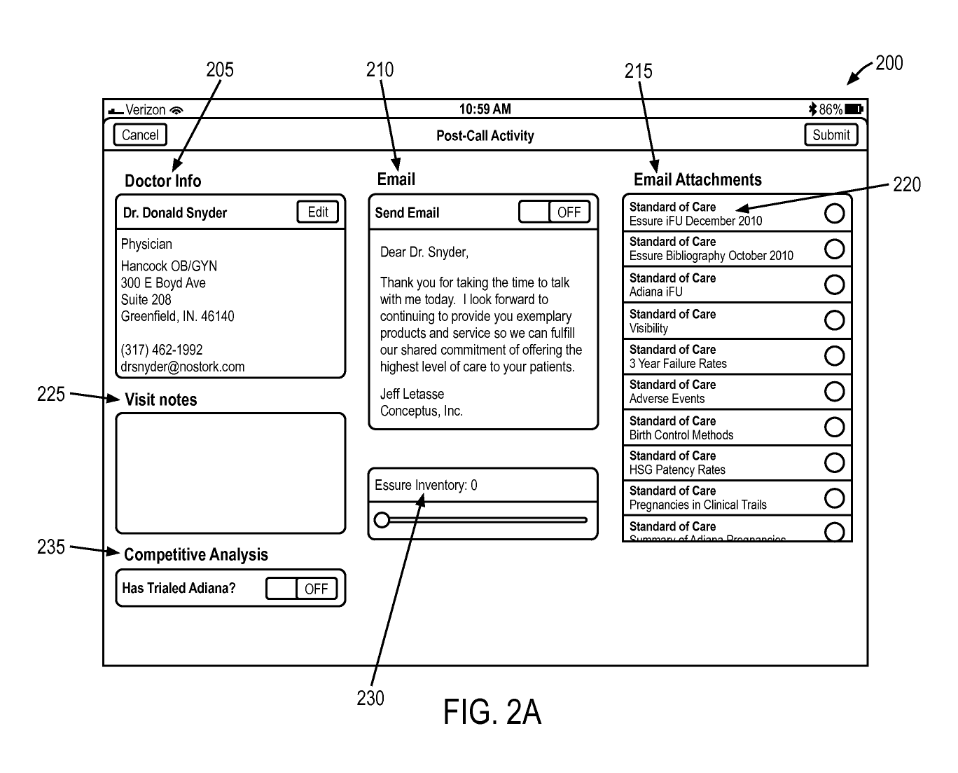

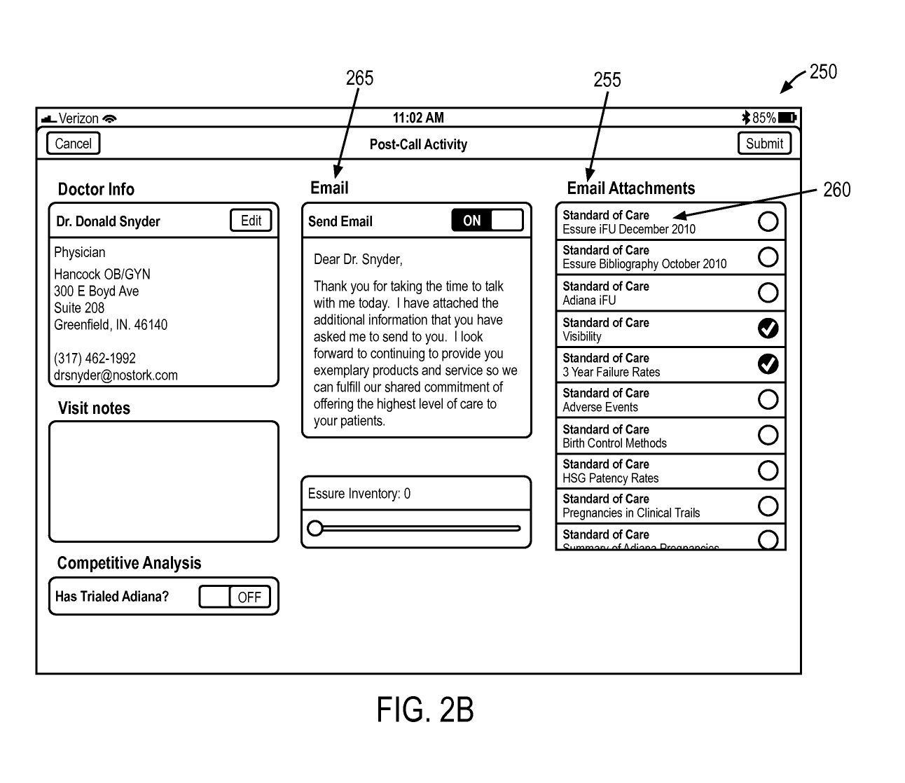

FIG. 2A illustrates an embodiment of an exemplary visual representation presented on a display of a tablet computing system by the “all-in-one” application. In one embodiment, the tablet computing system is one as described above in conjunction with FIG. 1.

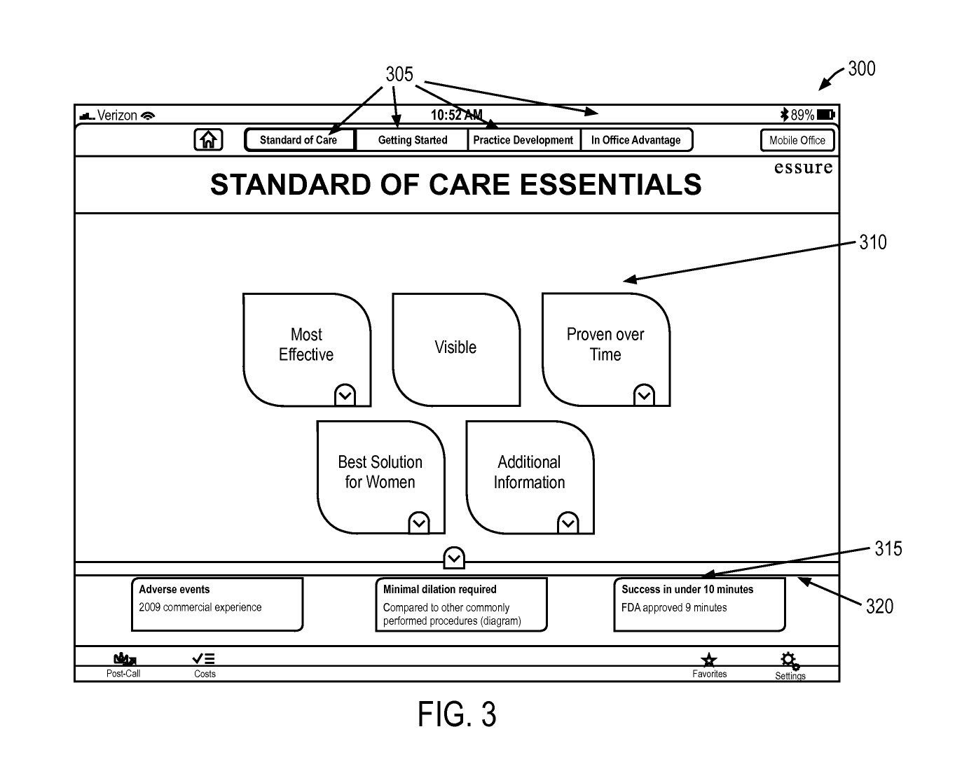

Referring to FIG. 2A, visual representation 200 allows a user (e.g., sales representative) to simultaneously see and interact with multiple viewing areas. In one embodiment, representation 200 can be the user interface provided to a sales person after a visit with a customer (“post call activity”). Visual representation 200 includes a contact information area 205 where a user can view information about a selected customer (e.g., as retrieved from a CRM data server) and edit the customer's contact information. Editing of the information about a selected customer in area 205 will cause changes in that information in a remote database maintained by a CRM server. Visual representation 200 can further include an email text entry area 210 where the user can enter text to include in an email to a customer. The user can select one or more of the available marketing materials 220 in email attachment list 215 to send as an attachment to the email being composed in the email text entry area 210. None of the marketing materials 220 are currently selected in the email attachment list 215. In one embodiment, an attachment can be identified by a link in the email. In this embodiment, the link (e.g., a URL) can be used by the recipient of the email (e.g., customer) to retrieve the attachment from, for example, a web server or email server. In an alternate embodiment, an attachment is directly attached to the email and is sent from system 105 and the recipient of the email (e.g., customer) can directly open the attachment from the email. The marketing materials 220 can be locally stored on the system 105 and be shown to a customer during a sales visit by the sales person using the system 105 to describe the product being sold. In addition, the same set of marketing materials can be stored on one or more web servers (or in databases coupled to those web servers such as database 140). The marketing materials 220 shown in FIG. 2A can be the same set of marketing materials that can be presented through the hierarchy of marketing data shown in FIG. 3. Thus, the sales person can use the hierarchical structure, as in FIG. 3, to provide a marketing presentation to a customer and then select attachments, from the list of possible attachments in list 215, to be sent to the customer. In this way, a presentation of a set of marketing materials through the application can then be followed up with a selection of attachments from the same set of marketing materials. This allows a sales person to use the hierarchical arrangement in FIG. 3 to guide the sales presentation in one phase or mode of use of the application and then switch to another phase or mode of use of the application to send an email with attachments that can be one or more of the marketing materials used in the sales presentation and all of these operations can be performed within one application (the “all-in-one” application). In one embodiment, all of the marketing materials that are available through the hierarchical arrangement of FIG. 3 are also available to be selectively sent as email attachments through a selection of the material in list 215.

It can be seen from FIG. 2A that a user (e.g., sales representative) can simultaneously see and interact, through a single panel or window on a display of system 105, with CRM data and create and send an email and select attachments to emails (from the set of marketing materials presented through the hierarchical arrangement shown in FIG. 3) and update information on product inventory. The user interface in FIG. 2A can be presented after a sales visit to a customer.

Visual representation 200 further includes a notes entry area 225, where the user can input notes about the customer displayed in customer information area 205. Visual representation area 200 can include an inventory entry area 230 which allows the sales person to edit the current information on the sales server based on the current inventory at the customer. Visual representation 200 can be used by the user to update the CRM and sales databases (e.g., CRM data 130 and sales data 135 of FIG. 1) through a secure internet protocol (e.g., server API 125 of FIG. 1). The updates performed using visual representation 200 can include which marketing materials were used (by the sales person at a visit to the customer) as tracked through a log of screens presented to the customer or sent by email. This log can be used to track which marketing materials (out of a set of such materials) are used and which are not used and their frequency or extent of use, and such tracking can be used to eliminate or change the marketing materials. Visual representation 200 can further include a competitive analysis area 235 that allows entry of information about a competitor's sales to the customer. In one embodiment, when competitive analysis area 235 is turned on, a user interface appears to enter information about a competitor's sales.

FIG. 2B illustrates an alternate embodiment of an exemplary visual representation presented on a display of a tablet computing system by the “all-in-one” application. In one embodiment, the tablet computing system is one as described above in conjunction with FIG. 1.

Referring to FIG. 2B, visual representation 250 allows a user (e.g., sales representative) to simultaneously see and interact with multiple viewing areas. Using visual representation 250, a user can select one or more of the available marketing materials 260 in email attachment list 255 to send as an attachment to the email being composed in the email text entry area 265. Currently, “Standard of Care Visibility” and “Standard of Care 3 Year Failure Rates” marketing materials 260 are currently selected in the email attachment list 255. These attachments can be sent as URLs in the email, and these URLs can cause the recipients system to retrieve the materials through the URLs.

FIG. 3 illustrates an exemplary visual representation of marketing data presented on a display of a tablet computing system by the “all-in-one” application. In one embodiment, the tablet computing system is one as described above in conjunction with FIG. 1.

Referring to FIG. 3, visual representation of marketing data 300 uses a hierarchy (e.g., tree) to allow a user (e.g., sales representative) to drill down through the hierarchy into a topic during a presentation of the marketing data. The marketing data can be grouped into one or more topics. In FIG. 3, the marketing data is grouped into main topics 305 (“Standard of Care”; “Getting Started”; “Practice Development”; and “In Office Advantage”). Each main topic 305 can be selected by tapping on (or otherwise selecting) the corresponding button at the top of visual representation 300. After selecting one of these main topics 305, a set of sub-topics 310 for the selected main topic 305 are displayed in the middle section as sub-topics for “Standard of Care.” Each of these sub-topics 310 can be selected to present a palette or tray of individual marketing materials, within a selected sub-topic 310, and each of the individual marketing materials can be represented by a graphic 315 in the tray 320 at the bottom of the screen. For example, as shown in visual representation 300, the graphics 315 at the bottom of the screen (“Adverse events”; “Minimal dilation required”; “Success in under 10 minutes”) represent three different, individual marketing materials which can be presented in response to selecting one of these graphics 315. Selecting one of the sub-topics 310 can present, in the tray 320, the corresponding set of individual marketing materials within that sub-topic 310. Selecting one of the individual marketing materials in the tray 320 causes the presentation of that marketing material (e.g., a movie, a slide of text, images, graphics, etc.). When a sub-topic 310 has multiple marketing materials, a selectable red down arrow appears on the graphics 315 of the sub-topic 310, and when this arrow is selected, the corresponding multiple marketing materials appear in that tray 320. If the tray 320 cannot show all of the icons for the individual marketing materials within a selected sub-topic 310, then the visual representation 300 allows horizontal scrolling in the tray to display all of them. A user (e.g., sales representative) can select and designate certain materials as favorites to allow their retrieval and use (from a list of favorites) without having to drill down through the hierarchy.

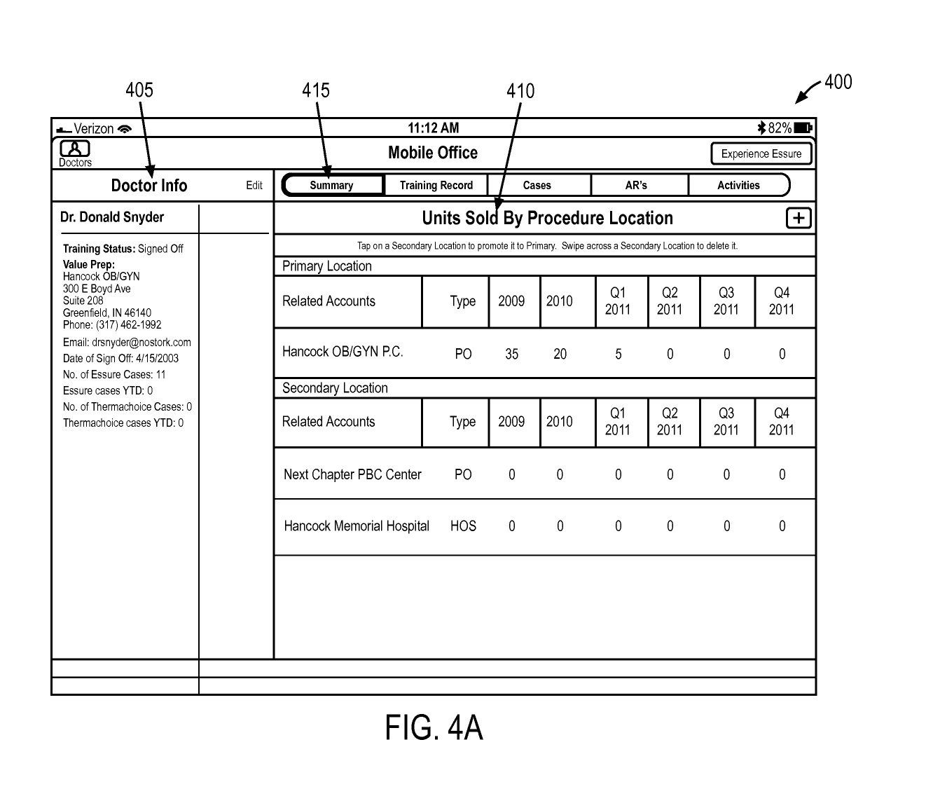

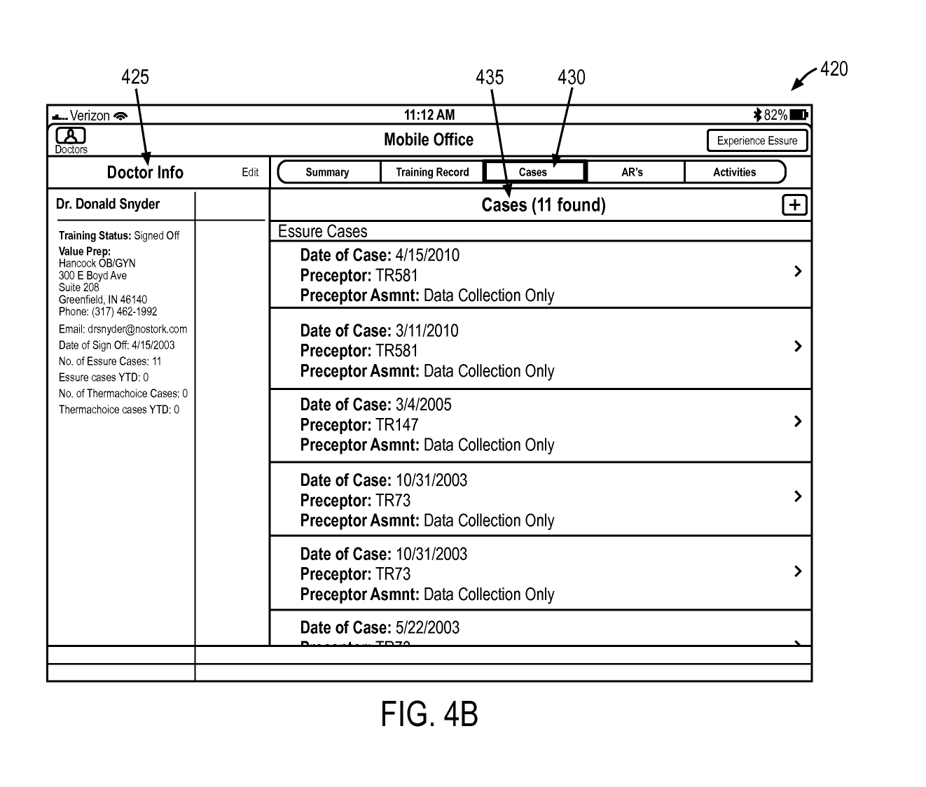

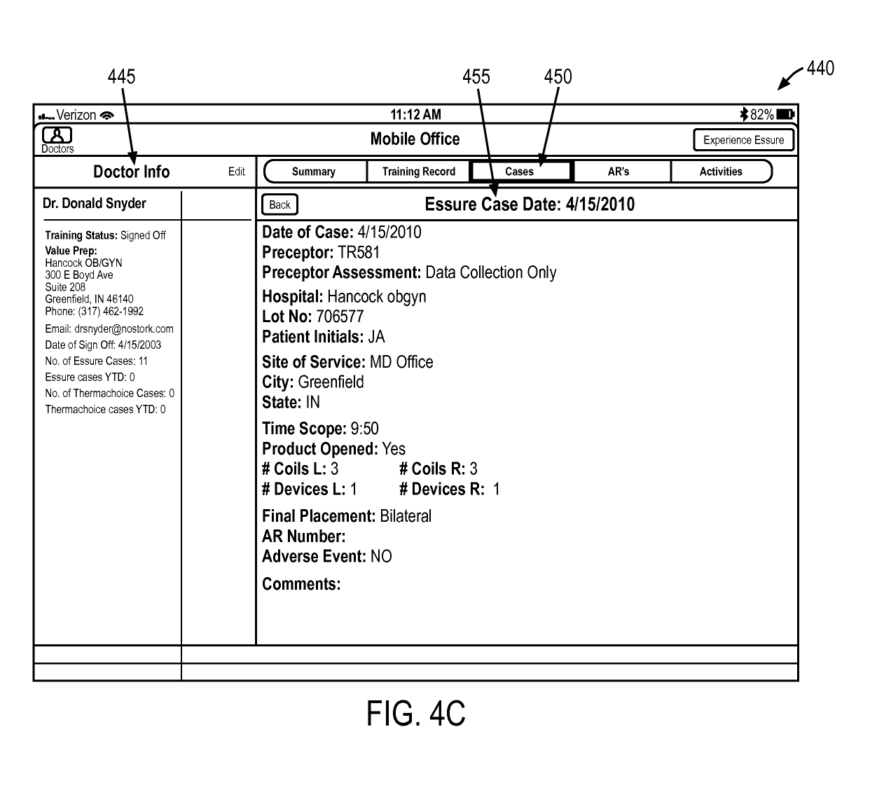

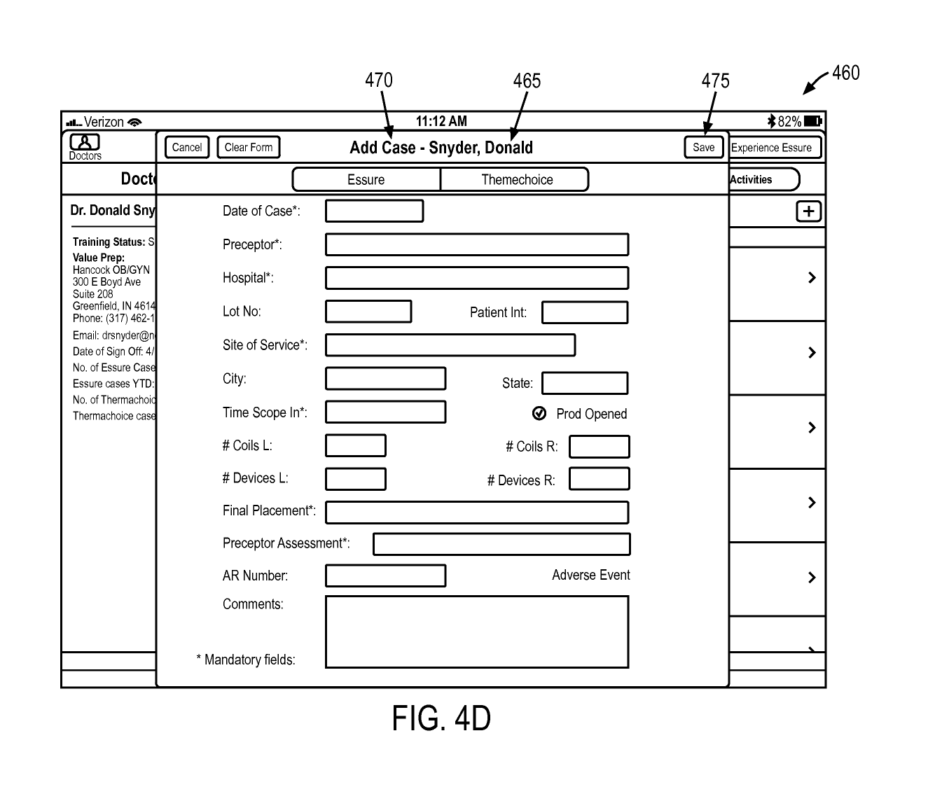

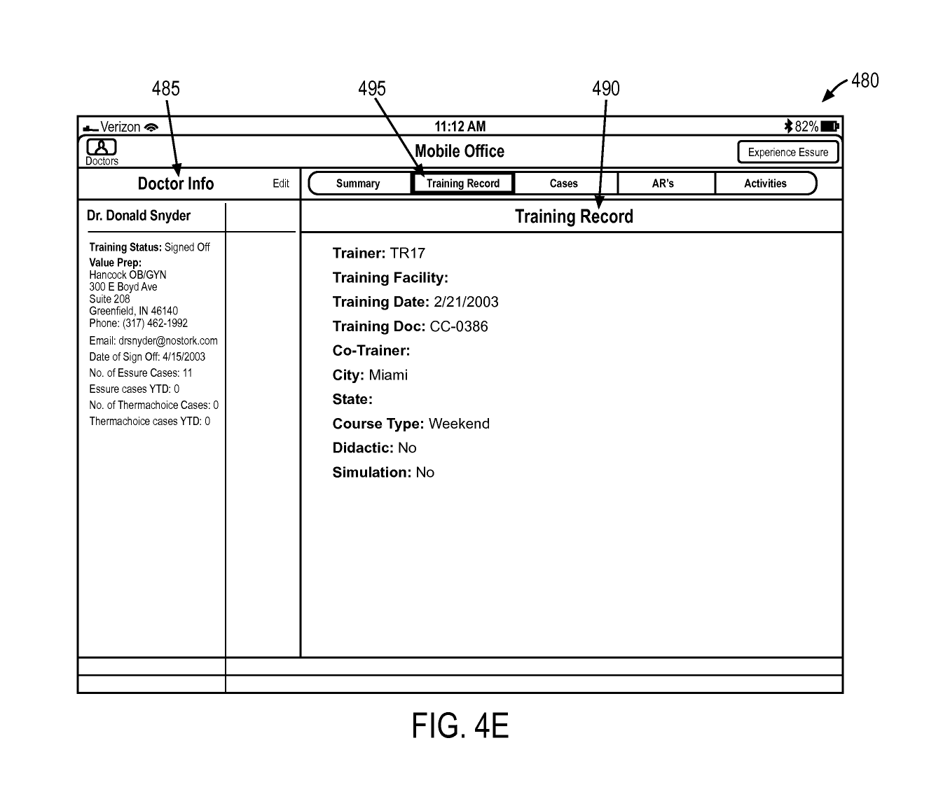

FIG. 4A illustrates an exemplary visual representation of CRM content presented on a display of a tablet computing system by the “all-in-one” application. In one embodiment, the tablet computing system is one as described above in conjunction with FIG. 1.

Referring to FIG. 4A, visual representation 400 includes a selected set of CRM content 405 and prior sales/inventory information 410. Visual representation 400 can include prior sales/inventory information 410 that describes the prior sales and inventory information for the selected set of CRM content 405 (e.g., a customer). Visual representation 400 can include a summary section 415 to show total sales at one or more locations when the summary section 415 is selected by a user.

In one embodiment, prior sales/inventory information 405 can be edited in visual representation 400 by the “all-in-one” application and these edits result in changes in a remote database such as CRM data 130 in FIG. 1. In an alternate embodiment, prior sales/inventory information 410 can be edited in an alternate visual representation (not shown).

FIG. 4B illustrates an exemplary visual representation of CRM content presented on a display of a tablet computing system by the “all-in-one” application. In one embodiment, the tablet computing system is one as described above in conjunction with FIG. 1.

Referring to FIG. 4B, visual representation 420 includes a selected set of CRM content 425. Visual representation 420 can include a cases section 430 to show individual sales and/or transactions for the selected set of CRM content 425 (e.g., a customer). Once the cases section 430 is selected by a user, the cases 435 (e.g., 11 cases) associated with the selected set of CRM content 425 (such as a selected customer) are displayed.

FIG. 4C illustrates an exemplary visual representation of CRM content presented on a display of a tablet computing system by the “all-in-one” application. In one embodiment, the tablet computing system is one as described above in conjunction with FIG. 1.

Referring to FIG. 4C, visual representation 440 includes a selected set of CRM content 445. Visual representation 440 can include a cases section 450 to show individual sales and/or transactions for the selected set of CRM content 445 (e.g., a customer). Once the cases section 430 is selected by a user, specific information for one sale 455 from a list of sales (e.g., cases 435 of FIG. 4B) associated with the selected set of CRM content 425 is displayed.

FIG. 4D illustrates an exemplary visual representation of CRM content presented on a display of a tablet computing system by the “all-in-one” application. In one embodiment, the tablet computing system is one as described above in conjunction with FIG. 1.

Referring to FIG. 4D, visual representation 460 includes a selected set of CRM content 465. Visual representation 460 can allow a user to input a new sale 470. Once the user has inputted data into the fields of new sale 470, the user can save 475 the sale information for the selected set of CRM content 465 (e.g., customer).

FIG. 4E illustrates an exemplary visual representation of CRM content presented on a display of a tablet computing system by the “all-in-one” application. In one embodiment, the tablet computing system is one as described above in conjunction with FIG. 1.

Referring to FIG. 4E, visual representation 480 includes a selected set of CRM content 485. Visual representation 480 can allow a user to input information about customer training record 490 by selecting the tracking record tab 495. Information about customer training record 490 can be edited by the user from within visual representation 480.

FIG. 5 illustrates an exemplary flow diagram of an all-in-one application method in accordance with embodiments of the present invention. Method 500 can be performed by processing logic that can comprise hardware (e.g., circuitry, dedicated logic, programmable logic, microcode, etc.), software (e.g., instructions run on a processing device), or a combination thereof. In one embodiment, each operation in method 500 is performed by all-in-one application 110 in tablet computing system 105 of FIG. 1.

Referring to FIG. 5, method 500 starts at block 510 to present marketing data on a visual display of a tablet computing system, such that the marketing data can be viewed by a user. In one embodiment, the marketing data is presented, through the hierarchical (topics, subtopics, etc.) arrangement shown in FIG. 3, by a sales representative and is viewed by a customer that the sales representative is visiting. The marketing data can include presentations, videos, text, graphics, or any other material that a sales representative may want to show to a customer and the marketing material can be stored in the tablet data store 125 and this marketing material can be sent as an attachment to an email sent through the post sales visit mode of the all-in-one application.

At block 520, method 500 can retrieve stored information from CRM data for processing or editing (such as CRM data from CRM database 130). In some embodiments, the retrieved information can include customer-specific data (e.g., CRM data) for a customer selected by the user (e.g., sales representative).

At block 530, method 500 can present a visual representation on a visual display of system 105 to allow a user (e.g., sales representative) to update or edit the retrieved CRM data. In some embodiments, the visual representation is a post-sales visit window (such as the windows shown in FIG. 2A or 2B) that can allow a user (e.g., sales representative) to simultaneously see and interact with multiple viewing areas to update information (e.g., CRM information, sales information, and inventory information). Moreover, once the visual representation is presented, the method 500 can determine what data was updated and send the updated content to the appropriate data structure. In one embodiment, the determination of whether the data was updated can be made by determining whether a specific field in the visual representation was modified. In an alternate embodiment, the determination of whether the data was updated can be made by comparing the original retrieved data and comparing it to the data saved or entered by the user.

At block 540, the all-in-one application can provide an email interface to allow the user (e.g., sales representative) to send an email to a customer visited by the user. In one embodiment, the email interface can be included in the visual representation presented by at block 530. In an alternate embodiment, the email interface is presented after the visual representation that allows the user to update or edit CRM content is presented. In one embodiment, the email interface can allow the user (e.g., sales representative) to send an email to a customer (e.g., customer just visited). In one embodiment, the email interface can allow the user to include an attachment to the email. In this embodiment, the attachment can be marketing material selected by the user via the visual representation to follow-up to a sales visit. In an alternate embodiment, the email interface can allow the user to include a link (e.g., URL) in the email to marketing material. In one embodiment, an indication can be sent that an email has been sent via the email interface.

In one embodiment, more than one visual representation is presented at block 540. For example, the user may select a specific customer for which CRM data is retrieved, then select several different marketing materials to send to the user. In one embodiment, method 500 can track each of the visual representations presented to a user and update CRM data based on the tracked visual representations. In one embodiment, the method 500 can track the visual representations by recording the visual displays in memory (such as recording the marketing materials presented, through the hierarchical arrangement in FIG. 3, in a visit to customers). In one embodiment, method 500 can track the marketing data that is selected, viewed, or attached in an email for a customer and update CRM information based on the tracked marketing data.

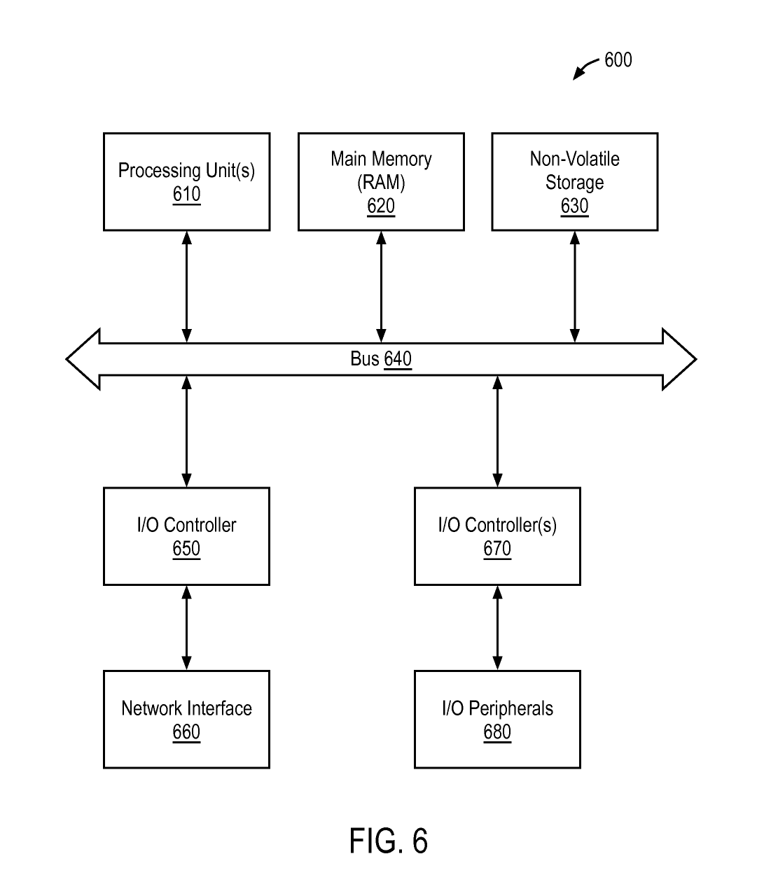

FIG. 6 is a block diagram of an exemplary tablet computer system in which embodiments of the present invention may operate. Tablet computer system 600 includes processing unit(s) 610, main memory (RAM) 620, non-volatile storage 630, bus 640, I/O controller 650, network interface 660, I/O controller 670, and I/O peripherals 680. In one embodiment, the I/O peripheral can include a touch sensitive display that includes a transparent capacitive sensing touch input device that is overlaid onto a display device such as the touch sensitive display on an iPad. The network interface can include one or more wireless transceivers such as WiFi transceivers or cellular telephone transceivers.

Main memory 620 encompasses all volatile or non-volatile storage media, such as dynamic random access memory (DRAM), static RAM (SRAM), or flash memory. Main memory 620 includes storage locations that are addressable by the processing unit(s) 610 for storing computer program code and data structures for an tablet all-in-one application. Such computer program code and data structures also may be stored in non-volatile storage 630. Non-volatile storage 630 includes all non-volatile storage media, such as any type of disk including floppy disks, optical disks such as CDs, DVDs and BDs (Blu-ray Disks), and magnetic-optical disks, magnetic or optical cards, or any type of media, and may be loaded onto the main memory 620. Those skilled in the art will immediately recognize that the term “computer-readable storage medium” or “machine readable storage medium” includes any type of volatile or non-volatile storage device that is tangible and non-transitory and accessible by a processor (including main memory 620 and non-volatile storage 630).

Processing unit(s) 610 is coupled to main memory 620 and non-volatile storage 630 through bus 640. Processing unit(s) 610 includes processing elements and/or logic circuitry configured to execute the computer program code and manipulate the data structures. It will be apparent to those skilled in the art that other processing and memory means, including various computer readable storage media, may be used for storing and executing computer program code pertaining to a tablet all-in-one application.

Processing unit(s) 610 can retrieve instructions from main memory 620 and non-volatile storage 630 via bus 640 and execute the instructions to perform operations described below. Bus 640 is coupled to I/O controller 650. I/O controller 650 is also coupled to network interface 660. Network interface 660 can connect to a network to download data required for a tablet all-in-one application.

Bus 640 is further coupled to I/O controller(s) 670. I/O controller(s) 670 are coupled to I/O peripherals 680, which may be mice, keyboards, modems, disk drives, optical drives, printers and other devices which are well known in the art.

The methods as described herein are not described with reference to any particular programming language. It will be appreciated that a variety of programming languages may be used to implement the teachings of the present invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be further appreciated that more or fewer processes may be incorporated into the method 500 in FIG. 5 without departing from the scope of the invention and that no particular order is implied by the arrangement of blocks shown and described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A computer-implemented method for an application comprising:
presenting, by the application on a computing system comprising a processor, marketing data on a visual display of the computing system viewable to a user;
retrieving, by the application on the computing system, stored information from a remote Customer Relationship Management (CRM) server for processing by the computing system;
presenting, by the application on the computing system, a visual representation on the visual display of the computing system to allow a user to update or edit CRM content; and
providing, by the application on the computing system, an email interface to allow the user to send an email to a customer visited by the user.

2. The computer-implemented method of claim 1, further comprising:
sending the CRM content to the remote CRM server, wherein the CRM content is one or more of CRM information, sales information, and inventory information.

3. The computer-implemented method of claim 2, wherein the email interface further comprises allowing the user to include an attachment to the email, wherein the computing system sends an indication to the remote CRM server that the user sent an email upon determining that an email was sent using the email interface, and wherein the attachment is one of the marketing data presented in the presenting of the marketing data.

4. The computer-implemented method of claim 3, wherein the visual representation comprises an email text entry area, an email attachment list, a notes entry area, a contact information area, and an inventory entry area.

5. The computer-implemented method of claim 4, further comprising:
sending, by the computing system, the updated content to a sales data structure upon determining that the updated content is related to the sales data structure.

6. The computer-implemented method of claim 5, further comprising:
tracking a plurality of visual representations presented to the user; and
updating information associated with the remote CRM server based on the tracked visual representations, wherein the visual representations comprise marketing materials presented by the computing system or sent by email using the computing system.

7. The computer-implemented method of claim 5, wherein the attachment is delivered from a web server through a link provided in the email.

8. The computer-implemented method of claim 3, wherein content of the email sent to the customer is stored at an email server and the remote CRM server, wherein the content of the email is not stored on the computing system, and wherein the attachment is sent directly from a server other than the computing system.

9. The computer-implemented method of claim 4, wherein the application represents the marketing data in a structured hierarchy, the structured hierarchy comprised of a plurality of topics, wherein each of the plurality of topics, when selected, display a plurality of sub-topics, and each of the plurality of sub-topics, when selected, display marketing material associated with the selected sub-topic.

10. The computer-implemented method of claim 9, wherein a sub-topic is associated with a plurality of marketing materials, and further comprising:
displaying a selectable graphic on the visual representation; and
upon selection of the selectable graphic, displaying the plurality of marketing materials associated with the sub-topic.

11. A computer-readable storage medium comprising executable instructions to cause a processor to perform operations for an application, the instructions comprising:
presenting marketing data on a visual display viewable to a user;
retrieving stored information from a remote Customer Relationship Management (CRM) server for processing;
presenting a visual representation on the visual display to allow a user to update or edit CRM content; and
providing an email interface to allow the user to send an email to a customer visited by the user.

12. The computer-readable storage medium of claim 11, wherein the instructions further comprise:
sending the CRM content to the remote CRM server, wherein the CRM content is one or more of CRM information, sales information, and inventory information.

13. The computer-readable storage medium of claim 12, wherein the email interface further allows the user to include an attachment to the email, and wherein the instructions further comprise:
sending an indication to the remote CRM server that the user sent an email upon determining that an email was sent using the email interface, wherein the attachment is one of the marketing data presented in the presenting of the marketing data, wherein the visual representation comprises an email text entry area, an email attachment list, a notes entry area, a contact information area, and an inventory entry area.

14. The computer-readable storage medium of claim 13, wherein the instructions further comprise:
sending the updated content to a sales data structure upon determining that the updated content is related to the sales data structure.

15. The computer-readable storage medium of claim 14, wherein the instructions further comprise:
tracking a plurality of visual representations presented to the user; and
updating information associated with the remote CRM server based on the tracked visual representations, wherein the visual representations comprise marketing materials presented by the application or sent by email using the application.

16. The computer-readable storage medium of claim 15, wherein the application represents the marketing data in a structured hierarchy, the structured hierarchy comprised of a plurality of topics, wherein each of the plurality of topics, when selected, display a plurality of sub-topics, and each of the plurality of sub-topics, when selected, display marketing material associated with the selected sub-topic.

17. The computer-readable storage medium of claim 16, wherein a sub-topic is associated with a plurality of marketing materials, and wherein the instructions further comprise:
displaying a selectable graphic on the visual representation; and
upon selection of the selectable graphic, displaying the plurality of marketing materials associated with the sub-topic.

18. A computer system comprising:
a memory; and
a processor configurable by instructions stored in the memory to:
present marketing data on a visual display of the computing system viewable to a user;
retrieve stored information from a remote Customer Relationship Management (CRM) server for processing by the computing system;
present a visual representation on the visual display of the computing system to allow a user to update or edit CRM content; and
provide an email interface to allow the user to send an email to a customer visited by the user.

19. The computer system of claim 18, wherein the email interface further allows the user to include an attachment to the email, wherein the computing system sends an indication to the remote CRM server that the user sent an email upon determining that an email was sent using the email interface, and wherein the attachment is one of the marketing data presented in the presenting of the marketing data.

20. The computer system of claim 18, wherein the visual representation comprises an email text entry area, an email attachment list, a notes entry area, a contact information area, and an inventory entry area.
